(19) United States
(12) Patent Application Publication
(10) Pub. No.: US 2023/0399195 A1
(43) Pub. Date: Dec. 14, 2023

(54) SELF-CONTAINED SEALED REFURBISHABLE TAPE BULK STORAGE SYSTEM

(71) Applicant: QUANTUM CORPORATION, San Jose, CA (US)

(72) Inventors: Turguy Goker, Vista, CA (US); Christian Allen Todd, Parker, CO (US); James P. Peng, Santa Maria, CA (US); Bruno Hald, Parker, CO (US)

(21) Appl. No.: 18/334,106

(22) Filed: Jun. 13, 2023

Related U.S. Application Data
(60) Provisional application No. 63/351,814, filed on Jun. 14, 2022.

(51) Int. Cl. B65H 51/22; B65H 27/00

(52) U.S. Cl. CPC B65H 51/22; B65H 27/00; B65H 2701/50; B65H 2701/37

(57) ABSTRACT

A tape storage system includes a system housing, a tape movement system and a tape head assembly. The system housing has a housing thickness that is not greater than 3.5 inches. The tape movement system is positioned within the system housing. The tape movement system includes a first reel and a second reel. The tape movement system is configured to retain a tape having a tape length of at least 2,000 meters. The tape head assembly is positionable within the system housing. The tape head assembly is configured to at least one of write data to and read data from the tape.

### RELATED APPLICATION

This application claims priority on U.S. Provisional Application Ser. No. 63/351,814, filed on Jun. 14, 2022, and entitled “SELF-CONTAINED SEALED REFURBISHABLE TAPE BULK STORAGE SYSTEM”. As far as permitted, the contents of U.S. Provisional Application Ser. No. 63/351,814 are incorporated in their entirety herein by reference.

### BACKGROUND

A data center is a building, a dedicated space within a building, or a group of buildings that are used to house computer systems and associated components, such as telecommunications and storage systems. Since IT operations are crucial for business continuity, the data center generally includes redundant or backup components and infrastructure for power supply, data communication connections, environmental controls, and various security devices.

For an entity or organization that owns and/or operates a data center, it is generally preferable to lower the total cost of ownership/operation (TCO) to the extent possible, while still maintaining the preferred volume of data storage capability. Tape TCO for a data center is a function of petabytes per cubic foot (PB/ft³). Generally speaking, the more petabytes of data storage per cubic foot that are attainable within the data center, the lower the TCO can be. One method for increasing the petabytes per cubic foot for the data center is to increase areal densities within individual storage devices. However, increasing the areal densities generally requires more complex magnetic storage technologies, which, in turn, requires higher non-recurring engineering (NRE) development costs.

Unfortunately, current technologies, such as those based on LTO cartridge dimensions or HDD-based dimensions, which include enclosed tape-based disk-like storage systems, all have limited volumetric efficiencies. For instance, a typical LTO-9 cartridge with 18 TB capacity when designed into a 19-inch rack-based system including robotics may result in 840 cartridges in an overall 48 U space, or 15.120 PB per 48 U rack. Additionally, use of smaller footprint storage devices such as LTO cartridges or HDD dimension-based small size tape storage systems increases fragmentation of the magnetic media, which can further lower volumetric efficiency. Thus, current systems having demands for increases on areal densities, with a push toward higher volumetric efficiency, limit what can be achievable due to various technical challenges.

Storage systems, such as those that use LTO tape cartridges and HDD, are often evaluated using Volumetric Recordable Area Factor (VRAF), which is defined as total recordable area divided by total volume. In one representative example, for an LTO-9 cartridge, the VRAF can be calculated generally based on the physical dimensions of the LTO-9 cartridge. In particular, an LTO-9 cartridge has the following physical dimensions and/or specifications including tape and servo format: (i) Tape width of 12.65 mm; (ii) Tape length of 1035 m; (iii) Cartridge width of 102 mm; (iv) Cartridge length of 105.4 mm; and (v) Cartridge thickness of 21.5 mm. An LTO-9 cartridge with such physical dimensions and/or specifications can provide a Tape Servo format efficiency of 88%. Based on these dimensions and/or specifications, LTO-9 has 11.5 m² recordable area in 0.00023 m³ of volume. Thus, the VRAF for LTO-9 is approximately 50,000.

In another representative example, for an HDD system with 9 platters, the physical dimensions and/or specifications include (i) Tracks per surface of 543,200; (ii) Track density of 482,000 Tracks/inch; (iii) Number of platters is 9; (iv) HDD width of 101.6 mm; (v) HDD length of 147 mm; and (vi) HDD thickness of 26.1 mm. An HDD system with such physical dimensions and/or specifications can provide an HDD volumetric efficiency of 88%. Based on these dimensions and/or specifications, HDD has a total recordable area of 0.077 m² in 0.0004 m³ of volume. Thus, in terms of VRAF, HDD has a factor of 192 which is substantially smaller than tape's VRAF of 50,000.

However, when utilizing tape to increase capacities, the storage system must still increase areal densities and/or the amount of tape in the cartridge. Unfortunately, such modifications bring substantial technical challenges and difficulties.

Current LTO-based storage systems use libraries where the basic building block is typically a 48 U 19-inch rack module. These modules have to assign space for robots and tape drives, and in some cases also server electronics to manage drives and library robots. Such additional requirements result in a limitation of how many cartridges can be stored in a 19-inch 48 U height rack module.

Thus, it is desired to provide a data storage system that increases the overall volumetric efficiency of tapes for data center deployments.

### SUMMARY

The present invention is directed toward a tape storage system. In various embodiments, the tape storage system includes a system housing, a tape movement system and a tape head assembly. The system housing has a housing thickness that is not greater than 3.5 inches. The tape movement system is positioned within the system housing. The tape movement system includes a first reel and a second reel. The tape movement system is configured to retain a tape having a tape length of at least 2,000 meters. The tape head assembly is positionable within the system housing. The tape head assembly is configured to at least one of write data to and read data from the tape.

In some embodiments, the housing thickness of the system housing is not greater than 1.75 inches.

In certain embodiments, the tape length of the tape is at least approximately 10,000 meters. In other embodiments, the tape length of the tape is at least approximately 15,000 meters. In still other embodiments, the tape length of the tape is at least approximately 20,000 meters.

In some embodiments, the system housing has a housing width that is not greater than 17.5 inches.

In certain embodiments, the tape is fixedly threaded to each of the first reel and the second reel.

In various embodiments, the tape storage system further includes one or more rollers that are configured to guide movement of the tape between the first reel and the second reel. In certain embodiments, at least one of the one or more rollers is positioned to contact a nonmagnetic coating on a back side of the tape.

In some embodiments, the tape storage system further includes a tape cleaning system that is positioned within the system housing, the tape cleaning system being configured to clean the tape.

In many embodiments, the tape storage system further includes a head cleaning mechanism that is positioned within the system housing, the head cleaning mechanism being configured to clean the tape head assembly.

In certain embodiments, the tape storage system further includes a tape lifter that can be selectively activated to move the tape away from the tape head assembly during movement of the tape between the first reel and the second reel.

In some embodiments, the tape storage system further includes a tape movement actuator that is configured to selectively move the tape between the first reel and the second reel.

In various embodiments, the tape storage system further includes control electronics that are configured to control operation of the tape head assembly and the tape movement actuator. In certain embodiments, the control electronics are coupled to the system housing. In alternative embodiments, the control electronics can be positioned within the system housing, or the control electronics can be positioned outside the system housing.

In many embodiments, the tape storage system further includes a power supply that is coupled to the system housing, the power supply being configured to supply power to the tape head assembly, the tape movement actuator, and the control electronics.

In certain embodiments, the system housing is sealed. In alternative embodiments, the system housing can be vacuum sealed, or the system housing can be non-vacuum sealed.

In certain embodiments, the tape storage system further includes a heat dissipation system that is coupled to the system housing, the heat dissipation system being configured to dissipate heat that is generated within the system housing during use of the tape storage system.

In certain embodiments, the tape is partitioned into a plurality of longitudinal and/or lateral partitions.

In various embodiments, the tape storage system further includes a second tape movement system that is positioned within the system housing, the second tape movement system including a third reel and a four reel, the second tape movement system being configured to retain a second tape having a second tape length of at least meters.

In many embodiments, the tape storage system further includes a second tape head assembly that is positionable within the system housing, the second tape head assembly being configured to at least one of write data to and read data from the second tape.

The present invention is also directed toward a tape storage system including a system housing having a housing thickness that is not greater than 2 U, a tape movement system that is positioned within the system housing, the tape movement system including a first reel and a second reel, the tape movement system being configured to retain a tape having a tape length of at least 2,000 meters; and a tape head assembly that is positionable within the system housing, the tape head assembly being configured to at least one of write data to and read data from the tape.

The present invention is further directed toward a method for storing tape including forming a system housing having a housing thickness that is not greater than 3.5 inches; positioning a tape movement system within the system housing, the tape movement system including a first reel and a second reel, the tape movement system being configured to retain a tape having a tape length of at least 2,000 meters; and positioning a tape head assembly within the system housing, the tape head assembly being configured to at least one of write data to and read data from the tape.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified top perspective view illustration of an embodiment of a tape storage system having features of the present invention;

FIG. 2 is a simplified bottom perspective view illustration of the tape storage system illustrated in FIG. 1;

FIG. 3 is a simplified perspective view illustration of two tape storage systems as illustrated in FIG. 1 that have been coupled and sealed together to form another embodiment of the tape storage system;

FIG. 4 is a simplified partially exploded perspective view illustration of a portion of the tape storage system illustrated in FIG. 3;

FIG. 5 is a simplified sectional view illustration of the portion of the tape storage system illustrated in FIG. 4;

FIG. 6 is a simplified schematic view illustration of a plurality of alternative configurations for reels usable within the tape storage system;

FIG. 7 is a simplified perspective view illustration of a portion of the tape storage system, including an embodiment of a tape head assembly usable within the tape storage system;

FIG. 8 is a simplified perspective view illustration of a portion of the tape storage system, including another embodiment of the tape head assembly; and

FIG. 9 is a simplified schematic view illustration of another embodiment of the tape storage system including another embodiment of the tape head assembly.

While embodiments of the present invention are susceptible to various modifications and alternative forms, specifics thereof have been shown by way of example and drawings, and are described in detail herein. It is understood, however, that the scope herein is not limited to the particular embodiments described. On the contrary, the intention is to cover modifications, equivalents, and alternatives falling within the spirit and scope herein.

### DESCRIPTION

Embodiments of the present invention are described herein in the context of a system and method that utilizes standard server dimensions, such as using 1 U of space with 19-inch depth rack dimensions, to design a totally sealed self-contained, self-managed, repairable and refurbishable reel-to-reel tape storage system where volumetric efficiency is achieved by enabling maximized tape surface area. Thus, utilizing such concepts, lower magnetic recording technologies can be used to achieve higher volumetric efficiencies. More particularly, with such systems and methods, by using lower magnetic recording technologies, typical substantial technical challenges and difficulties that often arise when requiring ever-increasing areal densities can be effectively avoided. The systems and methods of the present invention can also incorporate a design having a sealed system, where environmental restrictions are minimized, and with heat dissipation capabilities possible solely through simple air-cooling, which can be more cost-effective for the user. The present invention can also eliminate the need for robotics where 48 of these modules (or 24 double-sized modules) can fit within a 48 U 19″ rack system.

It is appreciated that this inventive concept, which, as noted, covers a sealed system, is a benefit for future tape systems, since next generation, high-capacity drives will be like operating tape drives as if they were HDD, but with totally open conditions that such a concept is made to address. This inventive concept may also be usable for low-profile, high storage density devices, such as 2 U, which are similar to server sizes.

It is further appreciated that this inventive concept is also potentially applicable to non-magnetic recording, with the best candidate being multi-layer optical recording which can be applied to a tape-like substrate system.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar reference indicators will be used throughout the drawings and the following detailed description to refer to the same or like parts.

In the interest of clarity, not all of the routine features of the implementations described herein are shown and described. It will, of course, be appreciated that in the development of any such actual implementations, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

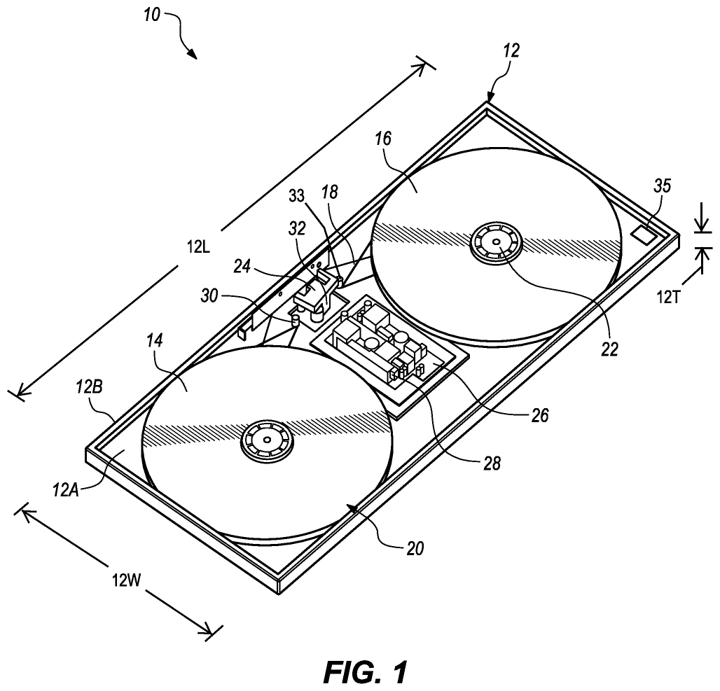

FIG. 1 is a simplified top perspective view illustration of an embodiment of a tape storage system 10 having features of the present invention. In particular, FIG. 1 illustrates an embodiment of the tape storage system 10 that uses 1 U of space with 19-inch depth rack dimensions, within a totally sealed self-contained, self-managed, repairable and refurbishable reel-to-reel tape storage system where volumetric efficiency is achieved by enabling maximized tape surface area. Thus, in such tape storage system 10, lower magnetic recording technologies can be used to achieve higher volumetric efficiencies. In various embodiments, the tape storage system 10 can incorporate built-in server technology, which can eliminate the need for outside servers, and, thus, can reduce overall cost and power consumption.

The design of the tape storage system 10 can be varied. In various embodiments, as illustrated in FIG. 1, the tape storage system 10 can include a system housing 12, a first reel 14 and a second reel 16 that cooperate to retain a tape 18 within a reel-to-reel tape movement system 20, at least one tape movement actuator 22, a tape head assembly 24, a power supply 26, and control electronics 28. Alternatively, the tape storage system 10 can have another suitable design, with more components or fewer components than those specifically noted.

As illustrated in this embodiment, the system housing 12 can be sized and shaped in accordance with the specifications for a 1 U system so that the tape storage system 10 uses 1 U of space with 19-inch depth rack dimensions. More particularly, in this embodiment, the system housing 12 can have a housing thickness 12T, a housing width 12W and a housing length 12L that are in accordance with the specifications for a 1 U system. Alternatively, the system housing 12 can be designed to utilize 2 U of space within the design of the individual tape storage system 10.

In this embodiment, the system housing 12 includes a housing base 12A, housing sides 12B, and a housing cover (not shown in FIG. 1 so that the components retained within the system housing 12 are clearly visible) that cooperate to provide a sealed box that uses 1 U of space with 19-inch depth rack dimensions. As described and as well understood in the industry, 1 U currently has the following overall dimensions: a housing thickness 12T of 1.73 inches multiplied by a housing width 12W of 17.4 inches multiplied by a housing length 12L of 36.4 inches. Thus, in this embodiment, the system housing 12 can be said to have (i) a housing thickness 12T that is less than or equal to approximately 1.75 inches (or not greater than 1.75 inches), (ii) a housing width 12W that is less than or equal to approximately 17.5 inches (or not greater than 17.5 inches), and (iii) a housing length 12L that is less than or equal to approximately 36.5 inches (or not greater than 36.5 inches). In this embodiment, the system housing 12 can additionally and/or alternatively be said to have a housing thickness 12T that is less than or equal to 1 U (or not greater than 1 U).

Alternatively, the system housing 12 can have another suitable design. For example, in one non-exclusive alternative embodiment, such as illustrated and described herein below, the system housing 12 can be designed with two substantially similar, if not identical, housing halves that include the housing base 12A and the housing sides 12B, but with one of the housing halves flipped over or inverted so that the housing halves can be sealed together to provide an overall sealed box that uses 2 U of space with 19-inch depth rack dimensions. Thus, for such alternative embodiment of the tape storage system 10, with the system housing 12 using 2 U of space with 19-inch depth rack dimensions, the system housing 12 can be said to have can be said to have a housing thickness 12T that is less than or equal to approximately 3.50 inches (or not greater than 3.50 inches). In such alternative embodiment, the system housing 12 can additionally and/or alternatively be said to have a housing thickness 12T that is less than or equal to 2 U (or not greater than 2 U). It is appreciated that in such alternative embodiments, no separate housing cover is required as the inverted housing half (the housing base of the inverted housing half) serves the function of the housing cover.

As utilized herein and illustrated in FIG. 1, and as well understood in the industry, the “housing thickness” is the smallest dimension of the sealed box that uses 1 U or 2 U of space with 19-inch depth rack dimensions, and is measured from the housing base 12A to the housing cover (or to the housing base 12A of the inverted housing half in the noted alternative embodiments).

As noted, the system housing 12 is configured to provide a sealed box environment for the various components of the tape storage system 10 that are retained within the system housing 12. In alternative embodiments, the sealed environment within the system housing 12 can be a non-vacuum environment or a vacuum environment.

In certain embodiments, the tape storage system 10 can further utilize a chemically inert gas, such as helium gas in one non-exclusive embodiment, for sealed internals, in order to remove undesired humidity. It is appreciated that humidity can be the main parameter that impacts Tape Dimensional Stability (TDS), thereby limiting track densities and providing robustness to corrosion, as well as providing a means for heat dissipation.

The first reel 14 and the second reel 16 of the tape movement system 20 are configured to retain the tape 18 as the tape 18 moves in either direction between the first reel 14 and the second reel 16. Because the tape storage system 10 of the present invention is a fully self-contained system, the tape 18 can be permanently threaded onto both the first reel 14 and the second reel 16, thereby obviating the need for a separate threading device where the tape 18 is threaded onto both reels 14, 16 during movement of the tape 18.

As shown, the reels 14, 16 can have a large diameter that can substantially fully fit the housing width 12W of the system housing 12, such that there is limited wasted space within the system housing 12. The precise size and positioning of the reels 14, 16 can be varied from what is specifically illustrated in FIG. 1. It is merely important that the tape movement system 20 include at least one pair of reels that are configured to move the tape 18 past the tape head assembly 24 so that data can be written to and/or read from the tape 18. In alternative embodiments, as illustrated and described herein below, the tape movement system 20 can include more than one pair of reels and/or the pair(s) of reels can be positioned in a different manner than what is shown in FIG. 1.

With the large design of the reels 14, 16, the tape storage system 10 is able to retain very long lengths of tape 18 that can thus retain volumes of data greatly in excess of what can typically be retained within an LTO cartridge of an LTO system. For example, in various embodiments, the reels 14, 16 can retain between 2,000 meters and 40,000 meters of tape 18, as compared to a standard LTO system in which the LTO cartridge is configured to retain just over 1,000 meters of tape. More particularly, in certain non-exclusive alternative embodiments, the reels 14, 16 can retain at least approximately 2,000 meters, 4,000 meters, 5,000 meters, 6,000 meters, 8,000 meters, 10,000 meters, 12,000 meters, 14,000 meters, 15,000 meters, 16,000 meters, 18,000 meters, 20,000 meters, 22,000 meters, 24,000 meters, 25,000 meters, 26,000 meters, 28,000 meters, 30,000 meters, 32,000 meters, 34,000 meters, 35,000 meters, 36,000 meters, 38,000 meters, or 40,000 meters of tape 18. It is appreciated that the length of the tape 18 that can be retained by the reels 14, 16 is dependent upon the overall size (diameter) of the reels 14, 16, as well as the thickness of the tape 18 itself. Alternatively, the reels 14, 16 can be configured to retain greater than 40,000 meters of tape 18 or less than 2,000 meters of tape 18.

Due to the greatly increased length of the tape 18, in various embodiments, the tape 18 can incorporate a Long Tape Logical format where the tape 18 is partitioned into a plurality of longitudinal partitions, and where the tape drive uses a limited tape section to write a full partition, thereby eliminating the tape wear problem due to high tracks per inch (TPI) application. In one example, with the potential for a 40,000 meters long tape and high TPI application such as 1000 wraps, this can cause the entire tape surface to undergo 1000 passes across the tape head assembly 24 to write a full volume to the tape. Additionally, searches for individual records stored on a tape can take much more time than on shorter tapes because, at nominal read speeds the time from the beginning of tape (BOT) to the end of tape (EOT) might be 120 minutes compared to the current time of approximately 3 minutes for a 1000-meter tape. Thus, by using a new longitudinal partitioned logical format, the noted wear and locate issues can be minimized, especially by enabling host software to use partitions near the end of tape (EOT) for older data, while also enabling the host software to make faster reads with partitions near the beginning of tape (BOT).

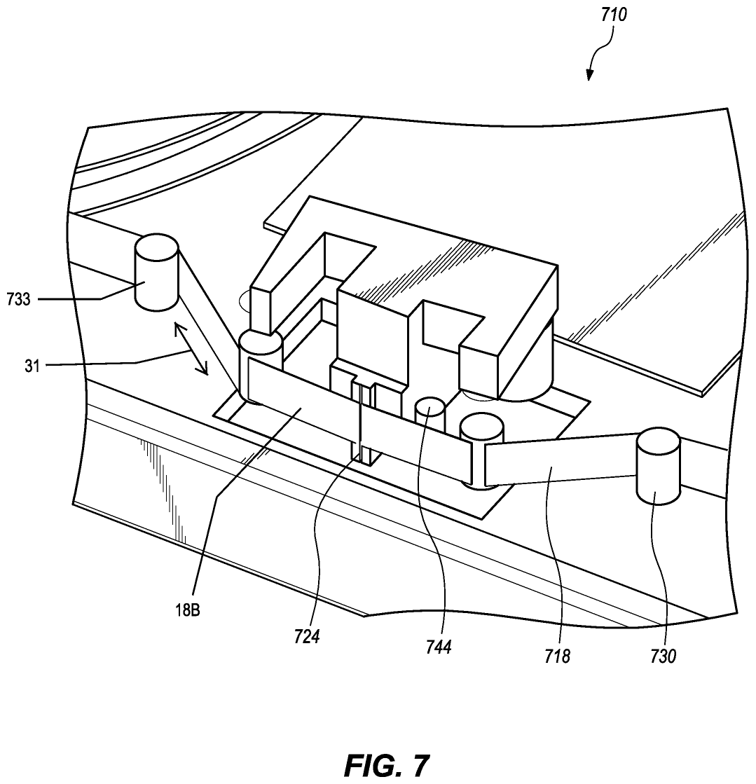

Additionally, and/or alternatively, in many embodiments, the tape 18 can be partitioned at least one of laterally and longitudinally into a plurality of logical and physical partitions. In some embodiments, the tape storage system 10 can include one or more actuator systems, which can each include one or multiple actuators, that can be positioned along a tape path 31 (illustrated, for example, in FIG. 7, with a two-headed arrow) with each of the multiple actuators being configured to work on different partitions of the tape 18 to increase the throughput of data. Additionally, or in the alternative, in certain embodiments, the one or multiple actuators can be utilized to individually move read heads and/or write heads within the tape head assemblies 24 (especially in embodiments that include multiple pairs of reels 14, 16). With this design, the one or multiple actuators within the one or more actuator systems can also reduce tape wear for applications demanding multiple uses of the tape 18 with frequent access to written data without wearing the tape head assembly 24 and the tape 18, and, thus, extending a life of the tape storage system 10.

It is appreciated that the reels 14, 16 can be designed to retain the tape 18 having any suitable tape width. In certain non-exclusive embodiments, the reels 14, 16 can be configured to retain the tape 18 having a tape width of between approximately ½-inch (similar to existing LTO tapes) and one inch. Alternatively, the reels 14, 16 can be configured to retain the tape 18 having a tape width of greater than one inch or less than ½-inch.

The tape movement actuator 22 can have any suitable design for purposes of moving the tape 18 between the first reel 14 and the second reel 16, and across the tape head assembly 24 in either direction for purposes of writing data to and/or reading data from the tape 18. In various embodiments, the tape movement actuator 22 can be configured to rotate the first reel 14 and/or the second reel 16 so that the tape 18 moves between the reels 14, 16 and across the tape head assembly 24 in either direction for purposes of writing data to and/or reading data from the tape 18. In one non-exclusive embodiment, the tape movement actuator 22 can be a brushless DC external rotary motor. Alternatively, the tape movement actuator 22 can have another suitable design.

In some embodiments, the tape storage system incorporates HDD-based or SSD-based deep buffer to enable tape motion without backhitches.

As illustrated in FIG. 1, the tape storage system 10 can further include one or more rollers 30 that are configured to guide movement of the tape 18 along the tape path 31 as the tape 18 moves between the first reel 14 and the second reel 16 and across the tape head assembly 24.

In certain embodiments, the tape storage system 10 can include built-in air entrainment elimination by using adaptive rollers 30 that provide pressure on the outside tape surface (i.e. the surface of the tape 18 away from the rotating portion of the roller 30) to squeeze air out, also providing real time tape radius per reel for power loss recovery.

In some embodiments, the rollers 30 can be positioned and/or configured so that at least some of the rollers 30 contact a nonmagnetic coating on a back side 18B (illustrated in FIG. 7) of the tape 18 to eliminate tape wear especially at high-speed motions.

In certain embodiments, the tape storage system 10 can also include a tape cleaning system 33 and/or a tape cleaning mechanism that is configured to clean particulates and/or other debris from the tape 18, preferably before the tape 18 moves across the tape head assembly 24. In some embodiments, the tape cleaning system 33 is coupled to and/or positioned within the system housing 12. For example, in certain non-exclusive alternative embodiments, the tape cleaning system 33 can be provided in the form of a tape burnishing roller that can be utilized as one of the rollers 30, and which can be configured to remove any particulates and/or other debris from the tape 18 before that tape 18 moves across the tape head assembly 24. In one embodiment, the tape burnishing can be controlled by firmware. More particularly, in such embodiment, the tape burnishing capabilities to enable, disable and/or adjust the degree of burnishing can be controlled by firmware. Alternatively, the tape cleaning system 33 can have another suitable design and/or the tape cleaning system 33 can be positioned in another suitable manner.

In various embodiments, the tape cleaning system 33 is configured to condition the tape 18 that is retained within the system housing 12. In some embodiments, the tape cleaning system 33 is configured to remove at least one of (i) abrasives, (ii) contaminants and (iii) lubricants that are on the tape 18 that is retained within the system housing 12.

The tape head assembly 24 can include one or more tape heads that are configured for writing data to and/or reading data from the tape 18 as the tape moves across the tape head assembly 24 at any desired speeds. As shown, the tape storage system 10 and/or the tape head assembly 24 can further include a tape head actuator 32 that is configured to move the tape head assembly 24 laterally so that the appropriate tape head is being used to write data to and/or read data from the tape 18 as desired. Because the tape head assembly 24 must be able to accommodate lateral movement between the tape 18 and the tape head assembly 24, it is appreciated that the tape head assembly 24 will typically have a height relative to the housing base 12A that is greater than the tape width. Thus, in embodiments of the tape storage system 10 that are configured to fit within the 1 U space, the tape width is limited by the required height of the tape head assembly 24 relative to the tape width, as the tape head assembly 24 must be short enough to fit within the sealed box of the system housing 12 within the 1 U of space. It is further appreciated then, that embodiments of the tape storage system 10 that are configured to fit within 2 U of space enable the use of the tape 18 having a tape width that is somewhat greater than the maximum tape width that is possible within the 1 U of space. This is because the height of the tape head assembly 24 need only be able to fit within the 2 U of space (or approximately 3.5 inches), as opposed to the 1 U of space (or approximately 1.75 inches) in the embodiment shown in FIG. 1.

In some embodiments, the tape movement system 20 can establish a long tape path 31 for purposes of enabling optimum lateral tape motion (LTM).

In certain embodiments, the tape head assembly 24 can utilize multiple head modules to trim tracks simultaneously for high PTI applications.

As illustrated in FIG. 1, the tape head assembly 24 is fully positioned and retained within the system housing 12. In one alternative embodiment, the tape head assembly 24 can be configured to be removed from the system housing 12 for repair, maintenance and/or replacement.

In one embodiment, the tape head assembly 24 can further include a data erase head for purposes of data elimination that can be used for security and/or when repairs of the tape storage system 10 are performed outside the data center in which the tape storage system 10 is operating.

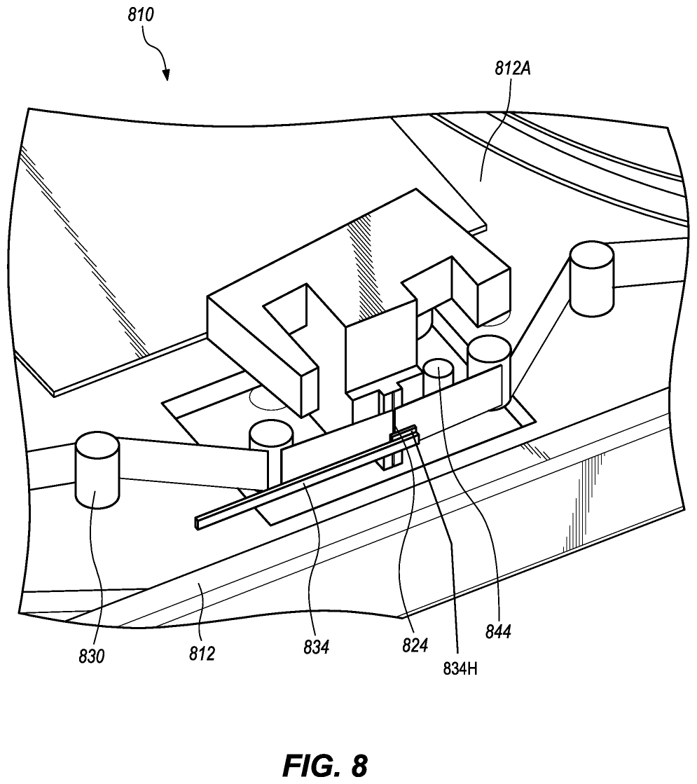

In some embodiments, the tape storage system 10 can further include a head cleaning mechanism 834 (illustrated in FIG. 8) that is configured to provide desired cleaning for the tape head assembly 24. The head cleaning mechanism 834 can have any suitable design for purposes of providing the desired cleaning for the tape head assembly 24, some of which are described in greater detail herein below.

The power supply 26 is configured to provide the necessary power to various components of the tape storage system 10, such as the tape movement actuator 22 and the tape head actuator 32. The power supply 26 can have any suitable design for purposes of providing the necessary power to the various components of the tape storage system 10.

The control electronics 28 are configured to provide desired control for various components of the tape storage system 10, such as the tape movement actuator 22 and the tape head actuator 32. The control electronics 28 can have any suitable design for purposes of providing the necessary control for the various components of the tape storage system 10. For example, the control electronics 28 can include one or more processors or circuits for purposes of providing the necessary control for the various components of the tape storage system 10.

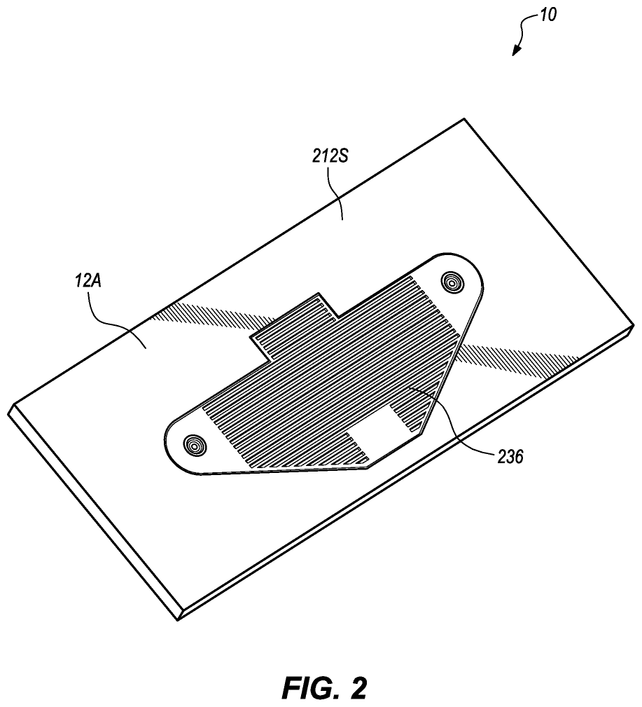

During use of the tape storage system 10, it is appreciated that the power supply 26 and the control electronics 28 are two of the components that will generate heat that could potentially impact the operation of the tape storage system 10. In the embodiment, illustrated in FIG. 1, the power supply 26 and the control electronics 28 are mounted on and/or secured to the housing base 12A within the sealed box of the system housing 12. In one alternative embodiment, in order to more effectively inhibit any heat generated by the power supply 26 and/or the control electronics 28 from potentially impacting the operation of the tape storage system 10, the power supply 26 and/or the control electronics 28 can be retained within a separate box that can be positioned outside the system housing 12 and/or coupled to an outer surface 212S (illustrated in FIG. 2) of the housing base 12A. For such alternative embodiment, it is appreciated that necessary electrical connections must be established through the system housing 12 so that the power supply 26 and the control electronics 28 can still provide the necessary power and control for the various components of the tape storage system 10.

In some embodiments, because the system housing 12 provides a sealed environment within which the tape storage system 10 operates, the tape storage system 10 can further include an air filter 35 (illustrated as a box) that is configured to remove internally generated debris through controlled air flow management.

As shown in FIG. 1, the reels 14, 16 are positioned relative to one another in a generally side-by-side arrangement, with the reels 14, 16 positioned within the same plane. In one non-exclusive alternative embodiment, the tape storage system 10 can use “overlapping reels” to enable using larger diameter reels to increase the efficiency of tape packed especially when using ½″ LTO media. Such configuration can be designed by placing the reels 14, 16 on top of each other, with maximum diameters for the reels 14, 16 being based on overall box dimensions. In such configurations, the tape 18 can be guided by servo controlled tilted rollers from one elevation to another, with the tape head actuator 32 and the heads of the tape head assembly 24 placed in the middle section where the tape 18 is guided parallel to the planar inner surface of the housing base 12A.

FIG. 2 is a simplified bottom perspective view illustration of the tape storage system 10 illustrated in FIG. 1. More particularly, FIG. 2 is a simplified bottom perspective view illustration showing an outer surface 212S of the housing base 12A. As shown, the tape storage system 10 can include a heat dissipating system 236 that can be coupled to and/or incorporated into the housing base 12A in order to dissipate heat that has been generated through use of the power supply 26 (illustrated in FIG. 1), the control electronics 28 (illustrated in FIG. 1), and/or any components (tape movement actuator 22, tape head actuator 32, etc.) that are powered and controlled thereby. The heat dissipating system 236 can have any suitable design for purposes of dissipating any heat that has been generated through use of the power supply 26 and/or the control electronics 28. In one non-exclusive embodiment, the heat dissipating system 236 can be provided in the form of a casting base that functions as a thermal heat sink, which can further be Peltier-assisted. Alternatively, the heat dissipating system 236 can have another suitable design.

As noted, many embodiments of the present invention are configured to fit within 1 U of space. Unfortunately, to enable tapes 18 (illustrated in FIG. 1) having a larger tape width, the tape head assembly may have a height that is too great to fit within the 1 U of space. Accordingly, certain alternative embodiments can be configured to fit within 2 U of space, and can utilize overlapping geometry.

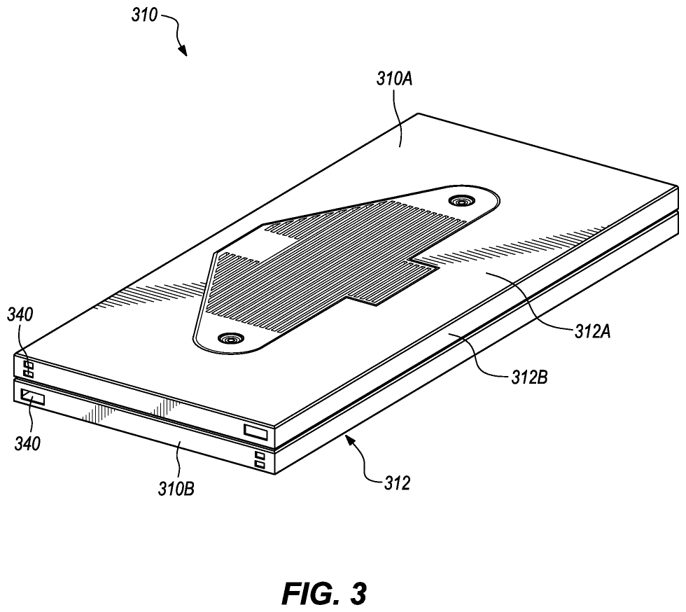

FIG. 3 is a simplified perspective view illustration of two tape storage systems 10, such as illustrated in FIG. 1, that have been coupled and sealed together to form another embodiment of the tape storage system 310. Although the interior details are not shown in FIG. 3, in various embodiments, the interior details of each of the individual tape storage systems 10 that have been sealed together to form the tape storage system 310 can be substantially identical to what has been illustrated and described herein above in relation to FIGS. 1 and 2. Accordingly, the various details of components of the tape storage system 10, 310, such as the reels 14, 16 (illustrated in FIG. 1) of the tape movement system 20 (illustrated in FIG. 1), the tape movement actuator 22 (illustrated in FIG. 1), the tape head assembly 24 (illustrated in FIG. 1), the power supply 26 (illustrated in FIG. 1) and the control electronics 28 (illustrated in FIG. 1), will not again be described in detail. However, it is appreciated that with the two individual tape storage systems 10 being sealed together to form this new embodiment of the tape storage system 310, the fully formed tape storage system 310 need not include a separate power supply and/or control electronics for each of the individual tape storage systems, but rather could include a single power supply and control electronics for the full tape storage system 310.

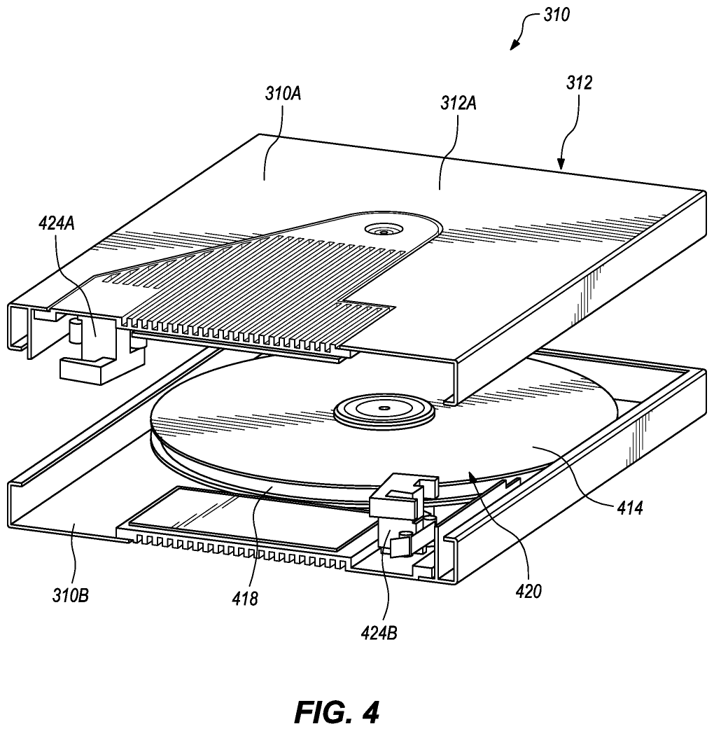

As shown in FIG. 3, the tape storage system 310 includes a first tape storage system half 310A and a second tape storage system half 310B that are substantially identical to the tape storage system 10 illustrated and described in detail with respect to FIGS. 1 and 2, with one of the tape storage system halves 310A, 310B being flipped and reversed so that all components can be positioned within the sealed box utilizing 2 U of space (with a housing thickness of 2 U (or nor greater than 3.5 inches)). In particular, the first tape storage system half 310A will have reels 14, 16 as part of a first tape movement system 20, a first tape movement actuator 22, and a first tape head assembly 424A (illustrated in FIG. 4); and the second tape storage system half 310B will have reels 14, 16 as part of a second tape movement system 20, a second tape movement actuator 22, and a second tape head assembly 424B (illustrated in FIG. 4).

For each tape storage system half 310A, 310B, because the tape storage system halves 310A, 310B are being sealed together, the system housing 312 for each tape storage system half 310A, 310B only includes the housing base 312A and the housing sides 312B. No separate housing cover is required for either of the tape storage system halves 310A, 310B because the system housing 312 of one tape storage system half 310A, 310B effectively functions as the housing cover for the other tape storage system half 310A, 310B.

With such design, the tape head assembly 24 for each tape storage system half 310A, 310B will be positioned on opposite sides, so that there is sufficient space for the full height of the tape head assembly 24, which may be greater than the 1 U of space for each individual tape storage system half 310A, 310B. Stated in another manner, the tape head assembly 24 for the first tape storage system half 310A will be on one side and the tape head assembly 24 for the second tape storage system half 310B will be on the opposite side, so that the tape head assemblies 24 have sufficient space for their full height and do not contact one another within the sealed box of the system housing 312.

As further shown in FIG. 3, the tape storage system 310 can include one or more external connection ports 340, such as ethernet connection ports, USB ports, or any other suitable external connection ports.

FIG. 4 is a simplified partially exploded perspective view illustration of a portion of the tape storage system 310 illustrated in FIG. 3. More particularly, FIG. 4 is a simplified partially exploded sectional view of the tape storage system 310 so that certain components inside the sealed box of the system housing 312 are visible. For example, as clearly illustrated within the system housing 312 of the tape storage system 310, a first tape head assembly 424A for the first tape storage system half 310A will be coupled to the corresponding housing base 312A on one side, and a second tape head assembly 424B for the second tape storage system half 310B will be coupled to the corresponding housing base 312A on the opposite side, so that the tape head assemblies 424A, 424B have sufficient space for their full height and do not contact one another within the sealed box of the system housing 312.

It is further appreciated that only one reel 414 that retains tape 418 is visible in FIG. 4. Within the entirety of the tape storage system 310, a separate reel-to-reel arrangement for the tape movement system 420 would be secured to the housing base 312A of each of the tape storage system halves 310A, 310B such that the tape movement systems 420 would be in a stacked arrangement. With such design, the overall tape storage system 310 would be able to provide a total length of tape 418 twice as long as that within the tape storage system 10 of FIG. 1. For example, in one non-exclusive embodiment, the tape movement system 420 for the first tape storage system half 310A could include approximately 20,000 meters of tape 418 retained on the corresponding reels 414, and the tape movement system 420 for the second tape storage system half 310B could also include approximately 20,000 meters of tape 418 retained on the corresponding reels 414. Thus, in such embodiment, the overall tape storage system 310 can include approximately 40,000 meters of tape 418. It is also appreciated that the length of tape 418 for either of the tape storage system halves 310A, 310B can be different than the specific example described, and/or the length of tape 418 for each tape storage system half 310A, 310B can be the same as the other or different from the other tape storage system half 310A, 310B.

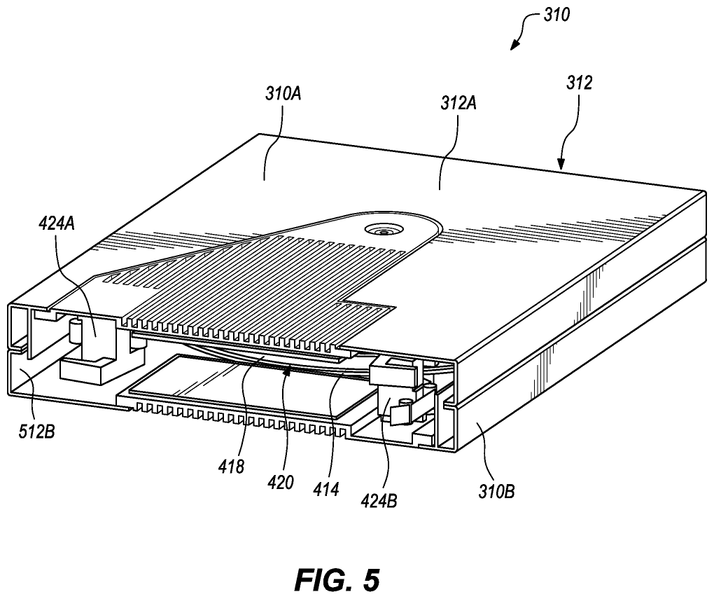

FIG. 5 is a simplified sectional view illustration of the portion of the tape storage system 310 illustrated in FIG. 4. In particular, FIG. 5 is a simplified sectional view illustration of the portion of the tape storage system 310 illustrated in FIG. 4, with the tape storage system halves 310A, 310B now coupled and/or sealed together to form the full system housing 312. The tape storage system halves 310A, 310B can be coupled and/or sealed to one another in any suitable manner to form the full system housing 312, with the two tape movement systems 420, with corresponding reels 414 and tape 418, and the two tape head assemblies 424A, 424B retained therein. As shown, in this embodiment, the housing sides 512B of the first tape storage system half 310A are directly coupled and/or sealed to the housing sides 512B of the second tape storage system half 310B to provide the overall 2 U-sized sealed box for the system housing 312. As clearly illustrated within the system housing 312 of the tape storage system 310, the first tape head assembly 424A for the first tape storage system half 310A is coupled to the corresponding housing base 312A on one side, and the second tape head assembly 424B for the second tape storage system half 310B is coupled to the corresponding housing base 312A on the opposite side, so that the tape head assemblies 424A, 424B have sufficient space for their full height and do not contact one another within the sealed box of the system housing 312.

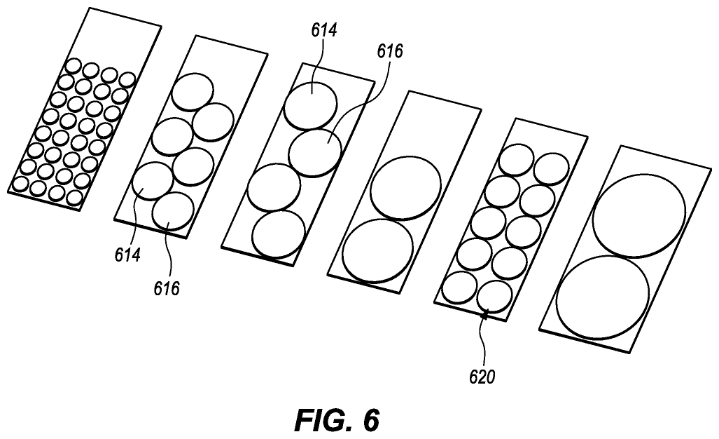

FIG. 6 is a simplified schematic view illustration of a plurality of alternative configurations for reels 614, 616 usable within the tape storage system, such as the tape storage system 10 illustrated in FIG. 1 and/or the tape storage system 310 illustrated in FIG. 3. In particular, in addition to the possible configuration for the reels 14, 16 illustrated most clearly in FIG. 1, the tape movement system 620 can include any alternative configuration including one or more pairs of reels 614, 616, with six potential alternative configurations being shown at least in part for demonstration purposes in FIG. 6. It is appreciated that the length of tape that can be retained by each pair of reels 614, 616 will depend on the size of the reels 614, 616. Thus, with smaller reels being utilized in each pair of reels 614, 616, such pairs of reels 614, 616 will be able to retain a lesser length of tape. Moreover, a separate tape head assembly 24 (illustrated, for example, in FIG. 1) will need to be available for each pair of reels 614, 616 for purposes of writing data to and/or reading data from the tape retained on the pair of reels 614, 616. However, the overall length of tape that can be retained within any configuration for the tape movement system 620 can be at least somewhat comparable, and the use of multiple pairs of reels 614, 616 can effectively provide a predefined partitioning of the overall tape length capacity for the tape movement system 620.

In embodiments utilizing multiple pairs of reels 614, 616, each pair of reels 614, 616 will be smaller than the maximum size possible when utilizing only a single pair of reels, but the movement from beginning of tape (BOT) to end of tape (EOP) will be faster for each pair of reels 614, 616. Thus, the predefined partitioning of the overall tape length capacity can enable improvements in overall speeds and volumetric efficiency.

FIG. 7 is a simplified perspective view illustration of a portion of the tape storage system 710, including an embodiment of a tape head assembly 724 usable within the tape storage system 710. More specifically, FIG. 7 illustrates certain features that can be included within the tape storage system 710 and/or the tape head assembly 724 that were not necessarily clearly visible in any of the other Figures illustrated and described herein.

As shown in FIG. 7, in various embodiments, the tape storage system 710 can include one or more rollers 730 that are configured to guide movement of the tape 718 along a tape path 31 and across the tape head assembly 724. In some embodiments, one or more of the rollers 730 can be configured to contacting the nonmagnetic coating on the back side 18B of the tape 718 to inhibit tape wear especially at high-speed motions. In certain embodiments, one or more of the rollers 730 can be tape burnishing rollers, as part of a tape cleaning system 733, to remove particulates and/or any other debris from the tape 718 before the tape head assembly 724, where burnishing is controlled (enabled, disabled and degree of burnishing) by firmware of the tape storage system 710.

As further shown in FIG. 7, in some embodiments, the tape storage system 710 and/or the tape head assembly 724 can incorporate a tape lifter 744 that is configured to selectively move the tape 718 away from the tape head assembly 724 during movement of the tape 718. In particular, in many embodiments, the tape lifter 744 can be selectively activated, such as through use of any suitable actuator, to move between a retracted position, where the tape lifter 744 does not contact the tape 718 or otherwise adjust the tape path 31, and an operational position, where the tape lifter 744 contacts the tape 718 to move the tape 718 away from its normal tape path 31 and away from the tape head assembly 724. Thus, the tape lifter 744 can selectively move the tape 718 away from the tape head assembly 724 when the tape 718 is moving so that certain portions of the tape 718 can be accessed as desired, but not during actual writing of data to and/or reading of data from the tape 718. Stated in another manner, the tape lifter 744 can be selectively activated to move the tape 718 at high speeds to eliminate unwanted tape motion across the tape head assembly 724, which would otherwise create wear and debris due to head to tape interface frictions.

FIG. 8 is a simplified perspective view illustration of a portion of the tape storage system 810, including another embodiment of the tape head assembly 824. As shown in FIG. 8, the tape storage system 810 and/or the tape head assembly 824 can again include one or more rollers 830 and a tape lifter 844 that are substantially similar in design and function as described in detail in relation to FIG. 7.

However, as shown in the embodiment illustrated in FIG. 8, the tape storage system 810 and/or the tape head assembly 824 can further include a head cleaning mechanism 834 that is coupled to and/or positioned within the system housing 812. In various embodiments, the head cleaning mechanism 834 is configured to clean the one or more heads of the tape head assembly 824 without requiring use of a separate cleaning tape.

The head cleaning mechanism 834 can have any suitable design for purposes of cleaning the one or more heads of the tape head assembly 824. For example, in one embodiment, the head cleaning mechanism 834 can include a brush that is coupled to the housing base 812A of the system housing 812, the brush including a brush head 834H that can be selectively moved across the tape head assembly 824. The brush head 834H can be formed from and/or include any suitable material that is able to remove particulates and/or any other debris from the heads of the tape head assembly 824.

In another embodiment, the head cleaning mechanism 834 can include a soft material with an optimized abrasivity roller-type mechanism that applies pressure against the head surface of the heads of the tape head assembly 824 while moving at a controlled linear speed.

In still another embodiment, the head cleaning mechanism 834 can include a wet clean process, which can incorporate an inkjet printer-type mechanism to apply industrial grade isopropyl alcohol to a soft material that can be used to wipe the head surface. Alternatively, the head cleaning mechanism 834 can have another suitable design.

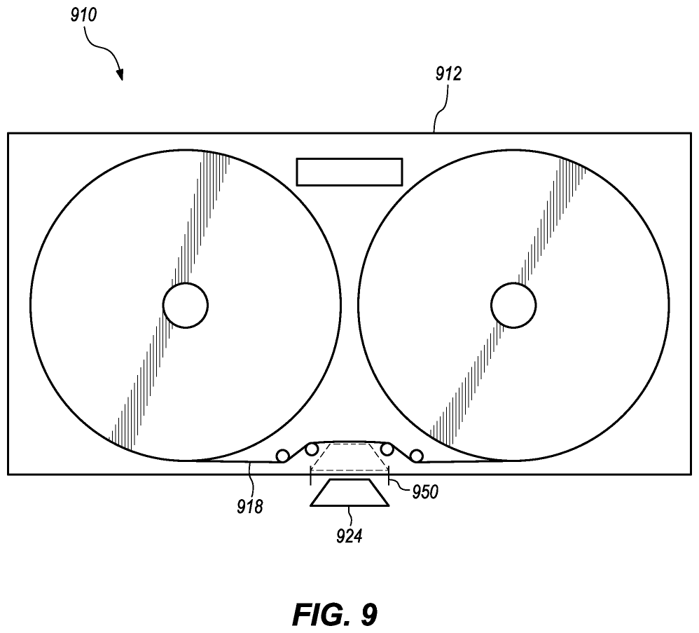

FIG. 9 is a simplified schematic view illustration of still another embodiment of the tape storage system 910 including still another embodiment of the tape head assembly 924. In particular, in this embodiment, the tape head assembly 924 is configured to be moved from an operational configuration (illustrated in dashed lines) where the tape head assembly 924 is positioned within the system housing 912 so that the tape head assembly 924 engages the tape 918 for purposes of writing data to and/or reading data from the tape 918, to a retracted configuration (illustrated in solid lines), where the tape head assembly 924 can be retracted from and/or positioned outside the system housing 912 for purposes of maintenance, repair or replacement, or as otherwise deemed appropriate.

In some embodiments, the tape head assembly 924 can be moved between the the operational configuration and the retracted configuration through a sealable opening 950 that is formed into the system housing 912. In one embodiment, the sealable opening 950 can be functionally incorporated as part of the tape head assembly 924. In another embodiment, the sealable opening 950 can be a fixed component provided as part of the system housing 912.

The tape head assembly 924 can have any suitable design for purposes of enabling the tape head assembly 924 to effectively move between the retracted configuration and the operational configuration. For example, the tape head assembly 924 can include one or more assembly movement actuators that are configured to move the tape head assembly 924 between the retracted configuration and the operational configuration.

One of the concepts of the present invention is to increase the overall volumetric efficiency of storage tapes for data center deployments, such that a robust capacity roadmap can be established by using older areal density technology such as LTO-7 and LTO-8 to establish a starting point for next generation tape-based data storage systems.

Current LTO-based systems use libraries where the basic building block is typically a 48 U 19-inch rack module. However, these modules have to assign space for robots and tape drives, and in some cases also server electronics to manage drives and library robots, thereby resulting in a limitation of how many cartridges can be stored in a 19-inch 48 U height rack module. In certain embodiments, the present invention involves integrating multiple cartridges and drive electronics into a single 1 U height 19-inch dimension, where the already efficient VFAR of the tape can be maximized even more, therefore not relying on super high technical inventions in magnetic media, heads, and other key technologies to achieve higher capacities for data centers. Individual tape storage systems 10, or storage modules, can also be oriented vertically and/or horizontally in any suitable manner within the overall 48 U height rack module to optimize recording volumetric efficiency, with the main parameter being the maximum recording area per 48 U 19-inch module. Also, the proposed system solves the key problems associated with air borne particles, temperature and especially humidity that otherwise cause inherent problems with dimensional stability for the tape.

As described, 1 U has the following overall dimensions, 1.73 inches thickness×17.4 inches width×36.4 inches length. In these dimensions, a sealed reel-to-reel tape drive can be designed with dedicated tape that can provide very long tape with larger than ½-inch width, and up to 1-inch widths or more in certain implementations. This concept uses large reels so fragmentation due to using many LTO-9 cartridges that also requires robotics and separate drives are eliminated, thus increasing the overall rack-based tape volumetric factor.

In some embodiments, using large reels in this form factor, it is possible to reach up to 40,000 meters of one-inch tape based on thickness, which is equivalent to having about 3800 LTO-9 cartridges plus drives and robotics. This enables the data storage system to use lower magnetic recording technology with earlier tapes and earlier heads to reach similar overall data capacities. For instance, an LTO-10 system with projected 38 TB would allow 840*36 TB=30.240 PB storage in a 48 U system with 10 LTO-9 drives. Similar capacity based on the present inventive method can use earlier LTO technology using earlier media; such as LTO-7 media with 9 TB Type M format, but 48 drives per rack not only increasing drive density but also volumetric density using older technology.

Some ideas incorporated into certain non-exclusive alternative embodiments to support the overall inventive concept include, but are not limited to:
1. Build in server technology, thereby eliminating the need for outside servers and reducing overall cost and power consumption;
2. Build in HDD-based or SSD-based deep buffer to enable tape motion without backhitches;
3. Build in air entrainment elimination by utilizing adaptive rollers that pressurize reel outside tape surface to squeeze air out, also providing real time tape radius per reel for power loss recovery;
4. Provide tape guiding where at least some of the guide rollers are contacting the nonmagnetic coating on the back side of the tape to eliminate tape wear especially at high-speed motions;
5. Incorporating a data erase head for data elimination for security and/or when repairing storage units is being performed outside the data centers;
6. Utilizing a tape cleaning system, such as tape burnishing rollers, to remove debris from the tape before the tape contacts the head assembly, where the burnishing is controlled (enabled, disabled and/or degree of burnishing) by firmware;
7. Incorporating a tape lifter to move the tape at high speeds to eliminate unwanted tape motion across the tape heads and/or the tape head assembly which would otherwise create wear and debris due to head to tape interface frictions, such as selectively moving the tape away from the tape head when moving along the tape to get to a desired longitudinal position without reading/writing during such movement;
8. Incorporating a head cleaning mechanism, such as with a brush having a brush head with debris removing built-in cleaning mechanism, to clean the tape heads without requiring cleaning tapes. Such a head cleaning mechanism can include a soft material with an optimized abrasivity roller-type mechanism that applies pressure against the head surface while moving at a controlled linear speed;
9. Incorporating a head cleaning mechanism, which can also and/or alternatively include a wet clean process using an inkjet printer-type mechanism to apply industrial grade isopropyl alcohol to a soft material that can be used to wipe the head surface;
10. Establishing a long tape path for optimum LTM (Lateral Tape Motion);
11. Using multiple head modules to trim tracks simultaneously for high TPI applications, i.e. simultaneous adjacent track trimming with multiple actuators;
12. Incorporating a Long Tape Logical format where the tape is partitioned into a plurality of longitudinal partitions where the tape drive uses a limited tape section to write a full partition, thereby eliminating the tape wear problem due to high TPI application. By way of example, with current format a 40,000 meters long media and high TPI application such as 1000 wraps will cause the entire tape surface to perform 1000 passes across the tape head assembly to write a full volume; and searches for individual records will result in excessive times since at nominal read speeds the time from BOT to EOT might be 120 minutes compared to current 1000 meter tapes which require only about 3 minutes. By using a new longitudinal partitioned logical format, the noted wear and locate issues can be minimized, especially enabling host software to use partitions near EOT for older data and making faster reads using partitions near BOT;
13. The tape can be partitioned at least one of laterally and longitudinally into a plurality of logical and physical partitions. The tape storage system can include dual actuators that are positioned along the same tape path with each of the dual actuators being configured to work on different partitions of the tape to increase the throughput of data and also reduce tape wear for applications demanding multiple uses of the tape with frequent access to written data without wearing the tape head assembly and the tape, and extending a life of the tape storage system;
14. Build in an air filter within the sealed housing to remove internally generated debris by controlled air flow management;
15. Using a heat dissipation system such as a specially designed base plate to remove heat from key power consuming devices, reel motors, and/or magnetic heads;
16. Build in tape and drive data analytics using machine-learning algorithms for predictive maintenance and repair;
17. Using a chemically inert gas such as helium gas for sealed internals to remove humidity, which is the main parameter for Tape Dimensional Stability, thereby limiting track densities and providing robustness to corrosion as well as providing a means for heat dissipation;
18. Using standard LTO FH or HH baseplate with its existing tape guiding rollers or new ones that are bigger in diameter with actuator and heads as a replaceable module with LTO electronics and modified firmware where the overall storage device has its own bigger reels and reel motors and special tape guiding tape path;
19. Potentially using “overlapping reels” to enable using larger diameter reels to increase the efficiency of tape packed especially when using typical ½-inch LTO media. Such configuration can be designed by placing reels on top of each with maximum diameters based on the overall box dimensions. In such an arrangement, the tape can be guided by servo controlled tilted rollers to move the tape from one elevation to the other, with actuator and head placed in a middle section where the tape is guided parallel to the base plate surface;
20. Understanding that the concept is not limited to simply designs with two reels in a box, but can alternatively include multiple pairs of reels where a pair is the minimum configuration where number of pairs is based on optimization of system for overall speeds and volumetric efficiency. It is appreciated that with multiple pairs of reels, each pair will be smaller than the maximum size possible when using only one pair, but then will be quicker to move from BOT to EOT within each tape (reel pair); and
21. Recognizing that the orientation of individual storage modules can be vertical and/or horizontal to optimize recording volumetric efficiency with main parameter being maximum recording area per 48 U 19-inch module.

Additionally, various embodiments of the tape storage system of the present invention can have the following specifications and/or can provide the following advantages:
A. Within 48 U of space, the tape storage system can have 48 drives maximum equivalent;
B. Even if each drive with its internal big reel of tape will move slowly, the aggregate 48 U will be higher than for a standard 10 drive LTO;
C. Each drive will move the tape at lower speeds so there is less friction and less wear;
D. No requirements of loading and threading of the tape within the system housing, so issues relating to the life of the tape and loading mechanisms is reduced;
E. The tape storage system does not need a tape threader as the tape can be fixedly threaded to each of the first reel and the second reel of the tape movement system; and
F. The specifications of certain non-exclusive embodiments include tape pack diameter of approximately 400 millimeters, motor diameter of approximately 90 millimeters, hub diameter of approximately 94 millimeters, tape length at 0.006 millimeters thickness of approximately 19787.32 meters, the overall tape storage system is 2 U tall (approximately 88.9 millimeters), with two 1 U devices mated together to allow over-height read/write hardware to nest into the opposite side.

It is understood that although a number of different embodiments of tape storage system have been illustrated and described herein, one or more features of any one embodiment can be combined with one or more features of one or more of the other embodiments, provided that such combination satisfies the intent of the present invention.

While a number of exemplary aspects and embodiments of tape storage system have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A tape storage system comprising:
a system housing having a housing thickness that is not greater than 3.5 inches;
a tape movement system that is positioned within the system housing, the tape movement system including a first reel and a second reel, the tape movement system being configured to retain a tape having a tape length of at least 2,000 meters; and
a tape head assembly that is positionable within the system housing, the tape head assembly being configured to at least one of write data to and read data from the tape.

2. The tape storage system of claim 1 wherein the housing thickness of the system housing is not greater than 1.75 inches.

3. The tape storage system of claim 1 wherein the tape length of the tape is at least 10,000 meters.

4. The tape storage system of claim 1 wherein the system housing has a housing width that is not greater than 17.5 inches.

5. The tape storage system of claim 1 wherein the tape is fixedly threaded to each of the first reel and the second reel.

6. The tape storage system of claim 1 further comprising one or more rollers that are configured to guide movement of the tape between the first reel and the second reel; and wherein at least one of the one or more rollers is positioned to contact a nonmagnetic coating on a back side of the tape.

7. The tape storage system of claim 1 further comprising a tape cleaning system that is positioned within the system housing, the tape cleaning system being configured to clean the tape.

8. The tape storage system of claim 1 further comprising a head cleaning mechanism that is positioned within the system housing, the head cleaning mechanism being configured to clean the tape head assembly.

9. The tape storage system of claim 1 further comprising a tape lifter that can be selectively activated to move the tape away from the tape head assembly during movement of the tape between the first reel and the second reel.

10. The tape storage system of claim 1 further comprising a tape movement actuator that is configured to selectively move the tape between the first reel and the second reel, and control electronics that are configured to control operation of the tape head assembly and the tape movement actuator; and wherein the control electronics are coupled to the system housing.

11. The tape storage system of claim 10 wherein the control electronics are positioned outside the system housing.

12. The tape storage system of claim 10 further comprising a power supply that is coupled to the system housing, the power supply being configured to supply power to the tape head assembly, the tape movement actuator, and the control electronics.

13. The tape storage system of claim 1 wherein the system housing is sealed.

14. The tape storage system of claim 1 further comprising a heat dissipation system that is coupled to the system housing, the heat dissipation system being configured to dissipate heat that is generated within the system housing during use of the tape storage system.

15. The tape storage system of claim 1 further comprising (i) a second tape movement system that is positioned within the system housing, the second tape movement system including a third reel and a four reel, the second tape movement system being configured to retain a second tape having a second tape length of at least approximately 2,000 meters; and (ii) a second tape head assembly that is positionable within the system housing, the second tape head assembly being configured to at least one of write data to and read data from the second tape.

16. A tape storage system comprising:
a system housing having a housing thickness that is not greater than 2 U;
a tape movement system that is positioned within the system housing, the tape movement system including a first reel and a second reel, the tape movement system being configured to retain a tape having a tape length of at least 2,000 meters; and
a tape head assembly that is positionable within the system housing, the tape head assembly being configured to at least one of write data to and read data from the tape.

17. The tape storage system of claim 16 wherein the housing thickness of the system housing is not greater than 1 U.

18. The tape storage system of claim 16 further comprising (i) a second tape movement system that is positioned within the system housing, the second tape movement system including a third reel and a fourth reel, the second tape movement system being configured to retain a second tape having a second tape length of at least approximately 2,000 meters; and (ii) a second tape head assembly that is positionable within the system housing, the second tape head assembly being configured to at least one of write data to and read data from the second tape.

19. A method for storing tape comprising:
forming a system housing having a housing thickness that is not greater than 3.5 inches;
positioning a tape movement system within the system housing, the tape movement system including a first reel and a second reel, the tape movement system being configured to retain a tape having a tape length of at least 2,000 meters; and
positioning a tape head assembly within the system housing, the tape head assembly being configured to at least one of write data to and read data from the tape.

20. The method of claim 19 further comprising the step of fixedly threading the tape to each of the first reel and the second reel.
